(19) United States
(12) Patent Application Publication
(10) Pub. No.: US 2016/0358164 A1
(43) Pub. Date: Dec. 8, 2016

(54) METHOD AND SYSTEM FOR DIGITAL CURRENCY TRANSACTION SIGNATURE AND DIGITAL CURRENCY TRANSACTION DEVICE THEREOF

(71) Applicants: DiQi, Inc, Apia (WS); WIFIRE OPEN NETWORK GROUP LIMITED, HONG KONG (HK)

(72) Inventors: Shih-Wei Liao, Taipei City (TW); Pang-Ting Huang, Taipei City (TW)

(21) Appl. No.: 14/874,481

(22) Filed: Oct. 5, 2015

(30) Foreign Application Priority Data
Jun. 5, 2015 (CN) 201510303168.4

(51) Int. Cl. G06Q 20/38; G06Q 20/22

(52) U.S. Cl. CPC G06Q 20/3829; G06Q 20/223; G06Q 2220/00

(57) ABSTRACT

A digital currency transaction signature method for a digital currency transaction device is provided. The method includes: signing a transaction to generate a first partially-signed transaction, and determining whether at least one second partially-signed transaction related to the transaction is stored in a signature pool of the digital currency transaction device; if yes, combining the first partially-signed transaction and the at least one second partially-signed transaction to obtain a signed transaction; and if no, taking the first partially-signed transaction as the signed transaction. The method further includes: determining whether the signed transaction is valid, and if the signed transaction is not valid, putting the first partially-signed transaction into the signature pool of the digital currency transaction device and broadcasting the first partially-signed transaction to a signature pool of at least one another digital currency transaction device from the signature pool of the digital currency transaction device.

### CROSS-REFERENCE TO RELATED APPLICATION

This application claims the priority benefit of China application serial no. 201510303168.4, filed on Jun. 5, 2015. The entirety of the above-mentioned patent application is hereby incorporated by reference herein and made a part of this specification.

### BACKGROUND OF THE INVENTION

Field of the Invention

The invention relates to a method and a system for digital currency transaction signature, and more particularly, to a method and a system for digital currency transaction multi-signature and a digital currency transaction device thereof.

Description of Related Art

With advancements in the network communication technologies and emergence and development of the digital currency, use of the digital currency as certification for on-line transaction has been widely adopted in on-line transacting, shopping and financial activities. Further, in order to effectively solve the issues of forgery, impersonation and falsification during the transaction, a signature is often used as a means for safeguarding the on-line transaction safety, so as to ensure the security and authenticity for the transaction.

However, in the existing network environment of the digital currency transaction, the transaction that requires signatures from multiple users can only be completed by each of the users by ways of transmitting the transaction with incomplete multisignature through external transmission methods such as Email, communication software or social application program. In other words, while transmitting the transaction within incomplete multisignature, besides additional security risks, problems of non-synchronized information among the users may also arise.

Accordingly, under the existing network environment of the digital currency transaction, it has become an important topic for the digital currency transaction nowadays as how to provide a convenient and reliable mechanism for multisignature to the users while enhancing the security of multisignature in the digital currency transaction.

### SUMMARY OF THE INVENTION

The invention is directed to a method and a system for digital currency transaction signature and a digital currency transaction device thereof, which are capable of effectively enhancing the security of multisignature in the digital currency transaction.

The invention provides a digital currency transaction signature method for a digital currency transaction device in a peer-to-peer network. The method includes: establishing a transaction, and signing the transaction to generate a first partially-signed transaction. The method also includes: determining whether at least one second partially-signed transaction related to the transaction is stored in a signature pool of the digital currency transaction device; if the at least one second partially-signed transaction related to the transaction is stored in the signature pool of the digital currency transaction device, combining the first partially-signed transaction and the at least one second partially-signed transaction to obtain a signed transaction; and conversely, if the at least one second partially-signed transaction related to the transaction is not stored in the signature pool of the digital currency transaction device, taking the first partially-signed transaction as the signed transaction. The method further includes: determining whether the signed transaction is valid; and if the signed transaction is not valid, putting the first partially-signed transaction into the signature pool of the digital currency transaction device and broadcasting the first partially-signed transaction to a signature pool of at least one another digital currency transaction device from the signature pool of the digital currency transaction device.

In an exemplary embodiment of the invention, the step of broadcasting the first partially-signed transaction to the signature pool of the at least one another digital currency transaction device includes: transmitting an inquiry signal to the at least one another digital currency transaction device; and receiving a response signal in response to the inquiry signal from the at least one another digital currency transaction device, wherein the response signal indicates whether the first partially-signed transaction is recorded in the signature pool of the at least one another digital currency transaction device.

In an exemplary embodiment of the invention, the digital currency transaction signature method further includes: when the response signal indicates that the first partially-signed transaction is not recorded in the signature pool of the at least one another digital currency transaction device, transmitting the first partially-signed transaction to the signature pool of the at least one another digital currency transaction device.

In an exemplary embodiment of the invention, the digital currency transaction signature method further includes: if the signed transaction is valid, putting the signed transaction into a memory pool of the digital currency transaction device and broadcasting the signed transaction to memory pools of other digital currency transaction devices in the peer-to-peer network.

The invention provides a digital currency transaction device, and the digital currency transaction device includes: a digital currency transaction establishing module, a digital currency transaction signing module and a digital currency transaction processing module. The digital currency transaction establishing module is configured to establish a transaction, the digital currency transaction establishing module is configured to sign the transaction to generate a first partially-signed transaction, and the digital currency transaction processing module is configured to determine whether at least one second partially-signed transaction related to the transaction is stored in a signature pool of the digital currency transaction device. If the at least one second partially-signed transaction related to the transaction is stored in the signature pool of the digital currency transaction device, the digital currency transaction processing module combines the first partially-signed transaction and the at least one second partially-signed transaction to obtain a signed transaction. Otherwise, if the at least one second partially-signed transaction related to the transaction is not stored in the signature pool of the digital currency transaction device, the digital currency transaction processing module takes the first partially-signed transaction as the signed transaction. The digital currency transaction processing module is further configured to determine whether the signed transaction is valid. If the signed transaction is not valid, the digital currency transaction processing module is further configured to put the first partially-signed transaction into the signature pool of the digital currency transaction device and broadcast the first partially-signed transaction to a signature pool of at least one another digital currency transaction device from the signature pool of the digital currency transaction device.

In an exemplary embodiment of the invention, the digital currency transaction processing module is further configured to transmit an inquiry signal to the at least one another digital currency transaction device. The digital currency transaction processing module is further configured to receive a response signal for replying the inquiry signal from the at least one another digital currency transaction device. The response signal indicates whether the first partially-signed transaction is recorded in the signature pool of the at least one another digital currency transaction device.

In an exemplary embodiment of the invention, when the response signal indicates that the first partially-signed transaction is not recorded in the signature pool of the at least one another digital currency transaction device, the digital currency transaction processing module is further configured to transmit the first partially-signed transaction to the signature pool of the at least one another digital currency transaction device.

In an exemplary embodiment of the invention, if the signed transaction is valid, the digital currency transaction processing module is further configured to put the signed transaction into a memory pool of the digital currency transaction device and broadcast the signed transaction to memory pools of other digital currency transaction devices in a peer-to-peer network.

The invention provides a digital currency transaction signature system, and the digital currency transaction signature system includes a plurality of digital currency transaction signature devices. The digital currency transaction devices are connected to one another via a peer-to-peer network. The digital currency transaction devices include a first digital currency transaction device and at least one second digital currency transaction device. The first digital currency transaction device is configured to establish a transaction and sign the transaction to generate a first partially-signed transaction. The first digital currency transaction device is further configured to determine whether at least one second partially-signed transaction related to the transaction is stored in a signature pool of the first digital currency transaction device. If the at least one second partially-signed transaction related to the transaction is stored in the signature pool of the first digital currency transaction device, the first digital currency transaction device combines the first partially-signed transaction and the at least one second partially-signed transaction to obtain a signed transaction. Conversely, if the at least one second partially-signed transaction related to the transaction is not stored in the signature pool of the first digital currency transaction device, the first digital currency transaction device takes the first partially-signed transaction as the signed transaction. The first digital currency is further configured to determine whether the signed transaction is valid. If the signed transaction is not valid, the first digital currency transaction device is further configured to put the first partially-signed transaction into the signature pool of the first digital currency transaction device and broadcast the first partially-signed transaction to a signature pool of at least one second digital currency transaction device from the signature pool of the first digital currency transaction device.

In an exemplary embodiment of the invention, the first digital currency transaction device is further configured to transmit an inquiry signal to the at least one second digital currency transaction device. The at least one second digital currency transaction device is configured to determine whether the first partially-signed transaction is stored in the signature pool of the at least one second digital currency transaction device according to the inquiry signal and transmit a response signal for replying the inquiry signal to the first digital currency transaction device.

In an exemplary embodiment of the invention, when the response signal indicates that the first partially-signed transaction is not recorded in the signature pool of the at least one second digital currency transaction device, the first digital currency transaction device transmits the first partially-signed transaction to the signature pool of the at least one second digital currency transaction device.

In an exemplary embodiment of the invention, if the signed transaction is valid, the first digital currency transaction device is further configured to put the signed transaction into a memory pool of the first digital currency transaction device and broadcast the signed transaction to memory pools of other digital currency transaction devices in a peer-to-peer network.

Based on the above, according to the method and the system for digital currency transaction signature, a broadcasting mechanism is established between the digital currency transaction devices, so that each of the digital currency transaction devices may transmit the signed transaction to one another through the broadcasting mechanism without relaying on the external transmission methods to transmit the transaction with incomplete multisignature. Accordingly, the bottleneck for using multisignature may be reduced and its security may be ensured.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a digital currency transaction signature system according to an exemplary embodiment.

FIG. 2A and FIG. 2B are schematic diagrams illustrating operating concepts of the digital currency according to an exemplary embodiment.

FIG. 3 is a schematic diagram illustrating operations of digital signatures of the digital currency according to an exemplary embodiment.

FIG. 4 is a block diagram illustrating a digital currency transaction device according to an exemplary embodiment.

FIG. 5 is an example illustrating operations of the digital currency transaction signature according to an exemplary embodiment.

FIG. 6 is an example illustrating operations of a broadcasting mechanism between the digital currency transaction devices according to an exemplary embodiment.

FIG. 7 is another example illustrating operations of the digital currency transaction signature according to an exemplary embodiment.

FIG. 8 is a flowchart illustrating a digital currency transaction signature method according to an exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to provide the convenient and reliable mechanism for multi-signature to the users under the existing network environment of the digital currency transaction, the invention aims to establish a broadcasting mechanism for transmitting the transaction between the digital currency transaction devices of the users, such that the transaction with incomplete multi-signature may be completed without using the transmission methods outside the network environment of the digital currency transaction. Accordingly, the security of multi-signature in the digital currency transaction may be enhanced.

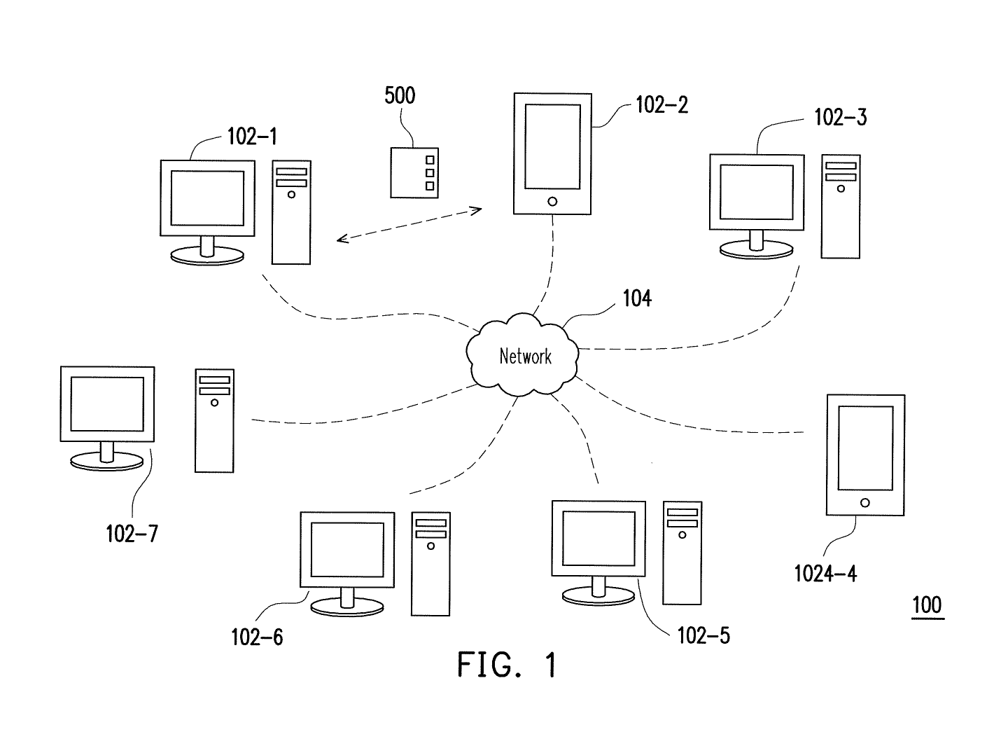

FIG. 1 is a schematic diagram illustrating a digital currency transaction signature system according to an exemplary embodiment. It should be understood that, the example of FIG. 1 is merely exemplary, and the invention is not limited thereto.

Referring to FIG. 1, a digital currency transaction signature system 100 includes a plurality of digital currency transaction devices 102-1 to 102-7, and said digital currency transaction devices are connected to one another via a network 104. For example, each of the digital currency transaction devices 102-1 to 102-7 may be a mobile device, a personal digital assistant (PDA), a notebook computer, a tablet computer, an ordinary desktop computer, or other electronic devices capable of communicating and transmitting data with one another through a wireless communication network. However, it should be understood that, although seven digital currency transaction devices are used in this example, the invention is not limited thereto. For example, the digital currency transaction signature system 100 may include even more digital currency transaction devices.

For example, in the present exemplary embodiment, the network 104 is a peer-to-peer (P2P) network. The P2P network is an Internet system not having a center server and relying only on information exchange between peers, which is capable of reducing the number of nodes in the conventional network transmission to lower the risk of data loss. The P2P network is different from a centralized network system having the center server. Nodes of the P2P network spread all over the entire Internet, and each of user terminals is one of the nodes having functionalities of the server. In particular, none of the nodes is able to directly locate the other nodes, and the information exchange must be performed relying on a user group. Because it is difficult to monitor the nodes of the P2P network, the P2P network is widely applied in fields with high standard for networking privacy. For example, network systems using the P2P network technology includes the Bitcoin network, the Gnutella network, the Freenet network and the like. It is worth mentioning that, the invention is not intended to limit the form of the network 104. For example, in another embodiment, the network 104 may also be other suitable network communication protocols, which are not particularly limited in the invention.

Referring back to FIG. 1, in the present exemplary embodiment, the digital currency transaction signature system 100 is built under a block chain network system of a digital currency. Specifically, said digital currency refers to a P2P network payment system and a virtual billing tool which adopt a cryptography technique for controlling production and transaction of the currency, and thus the digital currency is also regarded as a Cryptocurrency. For example, the digital currency may be an electronic currency such as the bitcoin, the litecoin and the infinitecoin.

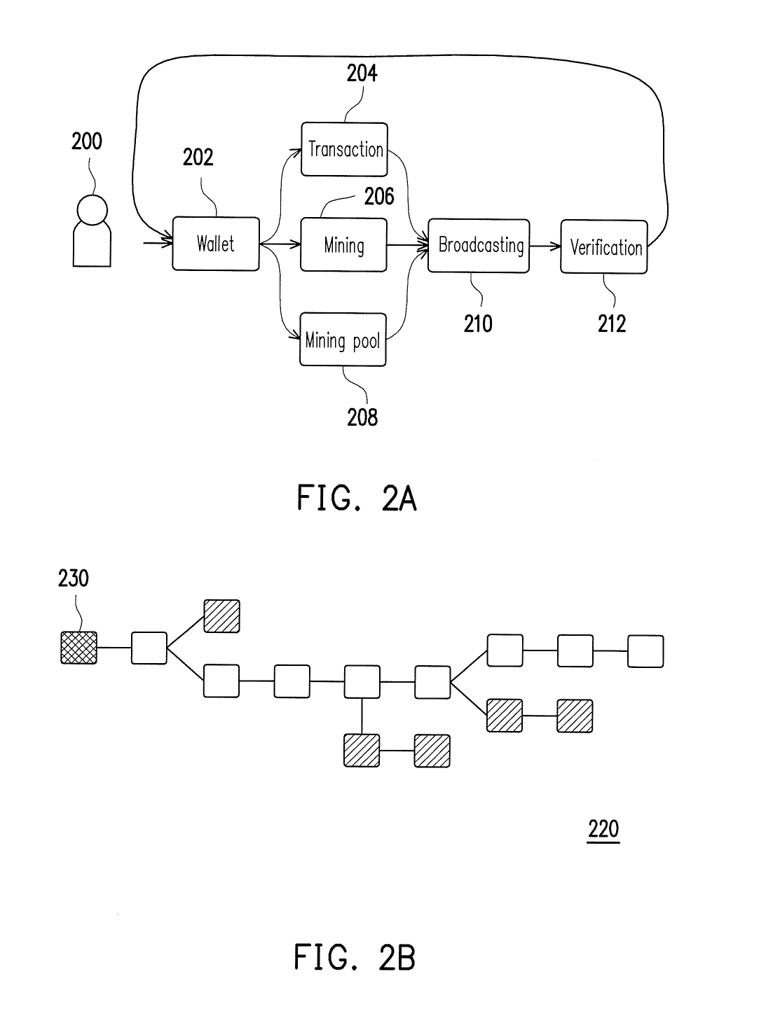

FIG. 2A and FIG. 2B are schematic diagrams illustrating operating concepts of the digital currency according to an exemplary embodiment.

Referring to FIG. 2, when a user 200 intends to use the digital currency for a transaction, the user 200 needs to use a digital currency wallet 202 on the digital currency transaction device as a tool for the transaction. The digital currency wallet 202 allows the user 200 to check, store, spend his/her owns digital currency. The digital currency wallet may be various tools operated in compliance with digit currency agreement, such as a computer user terminal, a cell phone user terminal, a website service, or a special purpose device. An operating method of the digital currency is similarly to Email, where the user 200 may use the digital currency wallet 202 and a corresponding address of the digital currency to receive the digital currency or pay the digital currency to other users. In the operating environment of the digital currency, a transaction 204 refers to circulation of the digital currency between the users or exchange between the digital currency and other currencies, goods or services. For example, the digital currency may be paid for advertisement or traded for daily necessities. Further, other than obtaining the digital currency through the transaction 204, the user 200 may also obtain the digital currency by participating a mining 206 or managing a mining pool 208. For instance, the user participating the mining 206 is known as a miner, the mining 206 refers to a process of obtaining the digital currency by the miner as transaction fees rewarded from verifying the transactions and recording the transactions, and the mining pool 208 is configured to combine computing power from among the miners for mining.

In particular, in the operating environment of the digital currency, information regarding each transaction must be broadcast to all the miners (and the mining poor) for verification. Also, the miner must participate the mining according to partial information of previous mining and received transaction information and also perform a verification 212 to determine a correctness of said information. A broadcasting 210 refers to a transmission of the transaction information performed in the P2P network via the Internet relay chat (IRC). Because the transmitting speeds in different networks may not be the same, the transmission information received by the miners may be different from one another. Accordingly, the partial information of the previous mining, new information and the received transaction information are bundled into one block by the miner who has mined the block, and the block is then transmitted to the other miners for verification.

Referring to FIG. 2B, one block is broadcast each time when the miner has mined the block, and the block chains to a previously-generated block to form a block chain 220. Each of the blocks in the block chain 220 may be used for backtracking to a first block 230. In other words, the user 200 may locate all the subsequent information starting from the first block 230. The block chain 220 includes a chain of blocks generated by their correlationship with use of a cryptographic method, and newly added block is connected to the previous block, (i.e., connected to a tail portion of the entire block chain 220). Because entire transaction history is stored in the block chain 220, the block chain 220 may be regarded as a ledger recorded with the transactions of the digital currency.

In an operating mechanism of the digital currency, a process of verifying one transaction is realized by a proof-of-work system for solving a series of computing challenges. Because the proof-of-work system requires the computing power of a computer to be at a specific level, a certain amount of times is required to solve the computing challenges. Accordingly, unless attackers have the computing power far stronger than the computing power of the entire P2P network in order to generate the block chain in a faster speed, the attackers are unable to rewrite the transaction history.

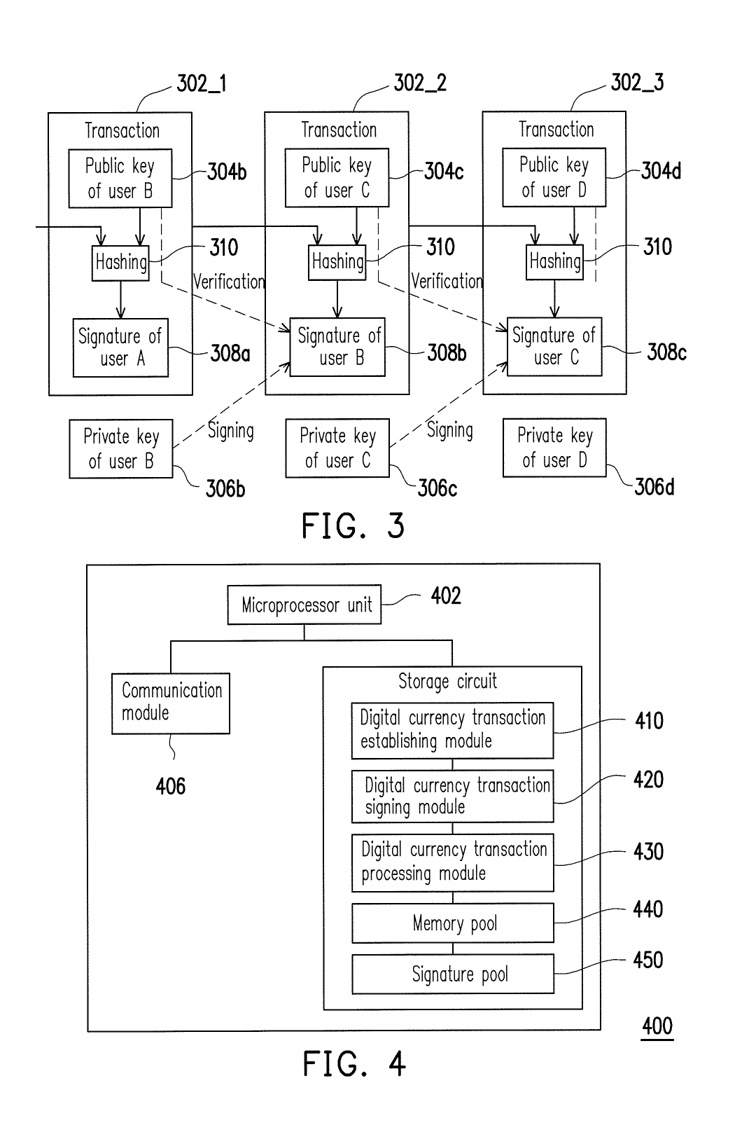

FIG. 3 is a schematic diagram illustrating operations of digital signatures of the digital currency according to an exemplary embodiment.

Referring to FIG. 3, in the present exemplary embodiment, a principle for operating with the digital signature of the digital currency is to achieve the digital signature based on a public key encryption algorithm, wherein the public key encryption algorithm includes two keys, which are a public key and a private key, respectively. Take a transaction 302_2 in FIG. 3 as an example, the transaction 302_2 refers to a process in which a user B transfers the digital currency to a user C. In the transaction 302_2, when the user B intends to transfer the digital currency to the user C, a public key 304c of the user C is used to generate an address of a digital currency wallet of the user C through calculation of a hashing 310, and a private key 306b of the user B is used to sign the transaction 302_2 where the hashing 310 is completed, so as to prove that the user B has indeed verified the transaction 302_2. Similarly, when the user C intends to use the digital currency from the transaction 302_2 to generate a transaction 302_3, the user C may complete the transaction by signing the transaction 302_3 with a private key 306c. In other words, the private key may be used to sign the transaction and provide a mathematical proof indicating that the transaction is indeed sent by the owner of said wallet, and the generated signature is capable of protecting the published transaction from being modified by other people.

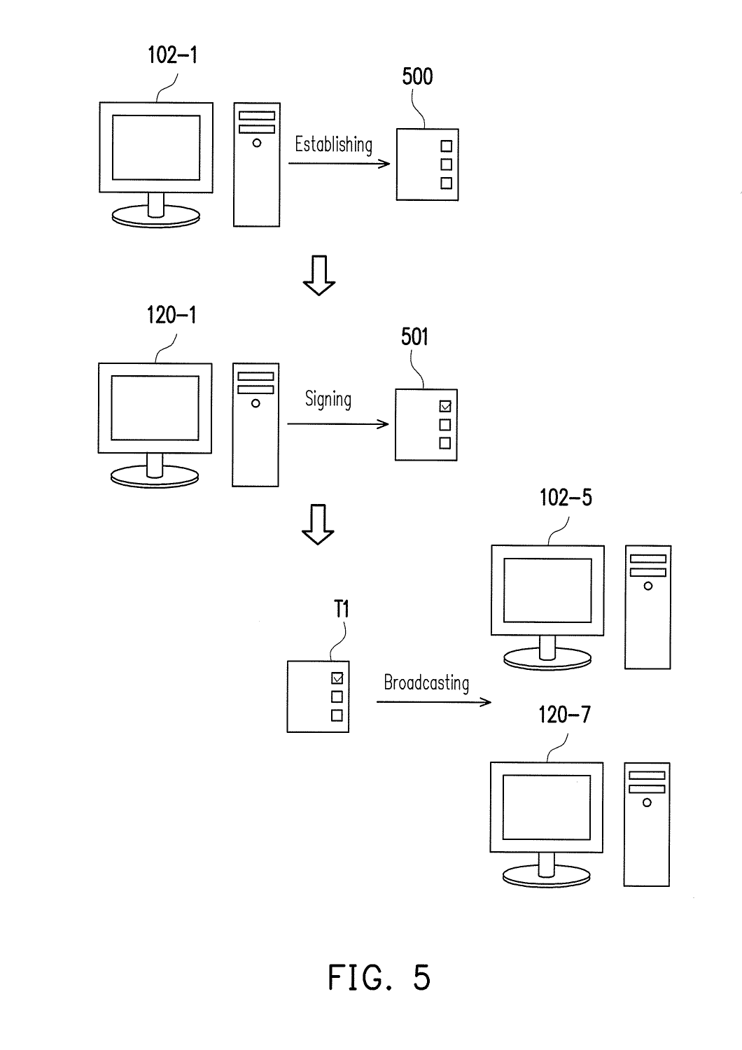

FIG. 4 is a block diagram illustrating a digital currency transaction device according to an exemplary embodiment, and FIG. 5 is an example illustrating operations of the digital currency transaction signature according to an exemplary embodiment.

In order to describe the operations of the digital currency transaction signature system 100 more clearly, an example is provided below with reference to the digital currency transaction signature system 100 of FIG. 1, a digital currency transaction device 400 of FIG. 4 together with FIG. 5.

Referring to FIG. 1, FIG. 4 and FIG. 5 together, the digital currency transaction device 400 includes a microprocessor unit 402, a storage circuit 404 and a communication module 406. In the present exemplary embodiment, the storage circuit 404 is stored with a digital currency transaction establishing module 410, a digital currency transaction signing module 420, a digital currency transaction processing module 430, a memory pool 440 and a signature pool 450. Among them, the memory pool 440 is a place where the transaction is stored before being recorded into the block, and the signature pool 450 is a specific place established in each of the digital currency transaction devices by the invention and configured to temporarily store each of partially-signed transactions. It should be noted that, in the exemplary embodiment of the invention, all the digital currency transaction devices 102-1 to 102-7 in FIG. 1 include the same elements and structures of the digital currency transaction device 400.

The microprocessor unit 402 is configured to control overall operations of the digital currency transaction device 400. For example, the microprocessor unit 402 may be a central processing unit (CPU). In particular, the microprocessor unit 402 issues a command to the digital currency transaction device 400 in order to execute the operations of the digital currency transaction signature between the digital currency transaction devices.

The storage circuit 404 is coupled to the microprocessor unit 402, and configured to temporarily store commands executed by the microprocessor unit 402 or data. For example, the storage circuit 404 stores software program codes of the digital currency transaction establishing module 410, the digital currency transaction signing module 420, and the digital currency transaction processing module 430. Later, when the digital currency transaction device 400 is enabled, said software program codes are loaded from the storage circuit 404 into a buffer memory of the digital currency transaction device 400 and executed by the microprocessor unit 402 to operate functions of said modules. In the present exemplary embodiment, the storage circuit 404 may be a Dynamic Random Access Memory (DRAM), or a Static Random Access Memory (SRAM) and the like. Nevertheless, it should be understood that the invention is not limited thereto, and the storage circuit 404 may also be other appropriate memories.

The communication module 406 is coupled to the microprocessor unit 402 and configured to communicate with other digital currency transaction devices outside the digital currency transaction device 400 via the network 104. For example, the communication module 406 of the digital currency transaction device 102-1 communicates with the digital currency transaction device 102-2 via the network 104. In the present exemplary embodiment, the communication module 406 communicates with the external digital currency transaction devices via the P2P network. However, it should be understood that, the invention is not limited thereto, and the invention is also suitable for other wireless communication networks.

The digital currency transaction establishing module 410 is configured to establish a transaction. For example, when the digital currency transaction device 102-1 intends to transfer the digital currency to the digital currency transaction device 102-2, the digital currency transaction establishing module 410 of the digital currency transaction device 102-1 establishes a transaction 500 corresponding to said activity.

The digital currency transaction signing module 420 is configured to sign the transaction to generate a partially-signed transaction (also known as a first partially-signed transaction). For example, the digital currency transaction signing module 420 of the digital currency transaction device 102-1 signs the transaction 500 to generate a first partially-signed transaction 501.

The digital currency transaction processing module 430 is configured to determine whether a partially-signed transaction related to the transaction 500 is stored in a signature pool of the digital currency transaction device 102-1. Herein, the partially-signed transaction related to the transaction 500 means that, in the case where the transaction 500 is valid only after being signed by the digital currency transaction device 102-1, the digital currency transaction device 102-5 and the digital currency transaction device 102-7, the partially-signed transaction related to the transaction 500 is the transaction respectively signed by the digital currency transaction device 102-1, the digital currency transaction device 102-5 and the digital currency transaction device 105-7.

In the present exemplary embodiment, when the digital currency transaction processing module 430 of the digital currency transaction device 102-1 determines that the partially-signed transaction related to the transaction 500 (hereinafter, also known as a second partially-signed transaction) is stored in the signature pool 450 of the digital currency transaction device 102-1, the digital currency transaction device 102-1 combines the first partially-signed transaction 501 and the second partially-signed transaction to generate a signed transaction. Conversely, if the digital currency transaction processing module 430 of the digital currency transaction device 102-1 determines that the second partially-signed transaction related to the transaction 500 is not stored in to the signature pool 450 of the digital currency transaction device 102-1, the digital currency transaction device 102-1 takes the first partially-signed transaction 501 as the signed transaction. For example, in the present exemplary embodiment, since the digital currency transaction processing module 430 of the digital currency transaction device 102-1 determines that the second partially-signed transaction related to the transaction 500 is not stored in the signature pool 450 of the digital currency transaction device 102-1, the digital currency transaction device 102-1 takes the first partially-signed transaction 501 as a signed transaction T1.

Subsequently, the digital currency transaction processing module 430 of the digital currency transaction device 102-1 determines whether the signed transaction T1 is valid, and puts the first partially-signed transaction 501 into the signature pool of the digital currency transaction device 102-1 if the signed transaction T1 is not valid. Thereafter, the first partially-signed transaction 501 is broadcast to a signature pool of at least another digital currency transaction device from the signature pool of the digital currency transaction device 102-1. Specifically, in the present exemplary embodiment, the transaction 500 can only be valid after being signed by the digital currency transaction device 102-1, the digital currency transaction device 102-5 and the digital currency transaction device 102-7, because the transaction 500 is only signed by the digital currency transaction device 102-1 at this moment, the digital currency transaction device 102-1 puts the first partially-signed transaction 501 into the signature pool 450 and broadcasts the first partially-signed transaction 501 to the signature pool 450 of the digital currency transaction device 102-5 and the signature pool 450 of the digital currency transaction device 102-7.

It should be noted that, the digital currency transaction establishing module 410, the digital currency transaction signing module 420, the digital currency transaction processing module 430, the memory pool 440 and the signature pool 450 are implemented by software modules or program codes. However, the invention is not limited thereto. For example, in another exemplary embodiment of the invention, the digital currency transaction establishing module 410, the digital currency transaction signing module 420, the digital currency transaction processing module 430, the memory pool 440 and the signature pool 450 may also be implemented by hardware circuits. For example, the digital currency transaction establishing module, the digital currency transaction signing module and the digital currency transaction processing module may be implemented by hardware circuits to be a digital currency transaction establishing circuit, a digital currency transaction signing circuit and a digital currency transaction processing circuit; and the memory pool 440 and the signature pool 450 may be implemented by register circuits.

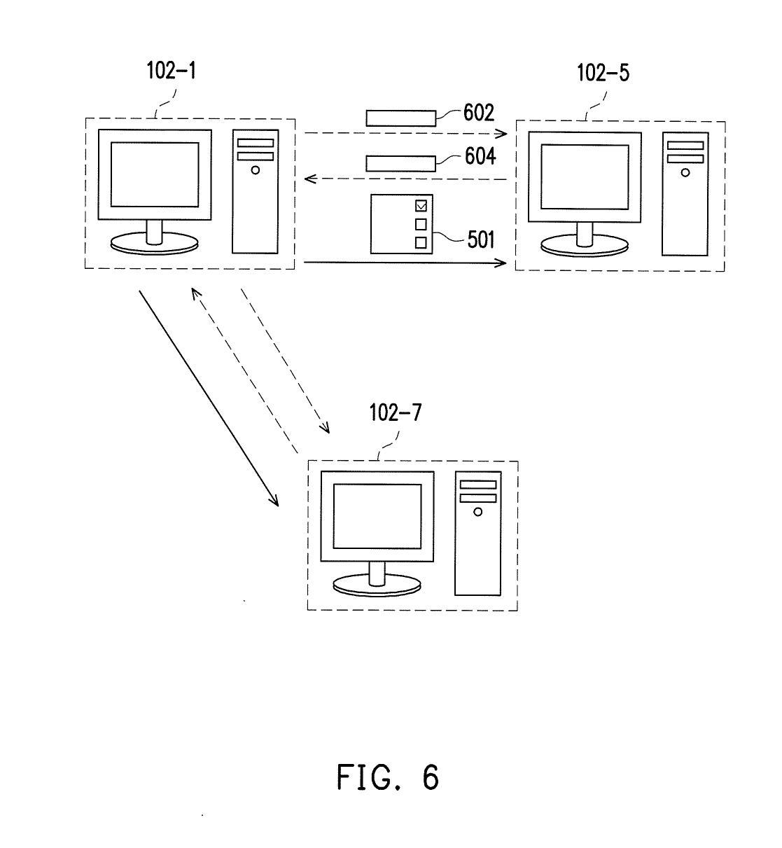

FIG. 6 is an example illustrating operations of a broadcasting mechanism between the digital currency transaction devices according to an exemplary embodiment.

Referring to FIG. 6, the digital currency transaction processing module 430 of the digital currency transaction device 102-1 transmits an inquiry signal 602 to the digital currency transaction device 102-5, and receives a response signal 604 for replying the inquiry signal 602 from the digital currency transaction device 102-5. Herein, the response signal 604 indicates whether the first partially-signed transaction 501 is recorded in the signature pool of the digital currency transaction device 102-5. For example, in the present exemplary embodiment, the digital currency transaction device 102-5 determines that the first partially-signed transaction 501 is not stored in the signature pool thereof. Accordingly, the digital currency transaction device 102-5 transmits the response signal 604 which indicates that the first partially-signed transaction 501 is not recorded in the signature pool of the digital currency transaction device 102-5. The digital currency transaction device 102-1 transmits the first partially-signed transaction 501 to the signature pool of the digital currency transaction device 102-5 according to the response signal 604. Similarly, the digital currency transaction processing module 430 of the digital currency transaction device 102-1 also transmits the inquiry signal 602 to the digital currency transaction device 102-7, and determines whether to transmit the first partially-signed transaction 501 to the digital currency transaction device 102-7 according to the response signal transmitted back from the digital currency transaction device 102-7.

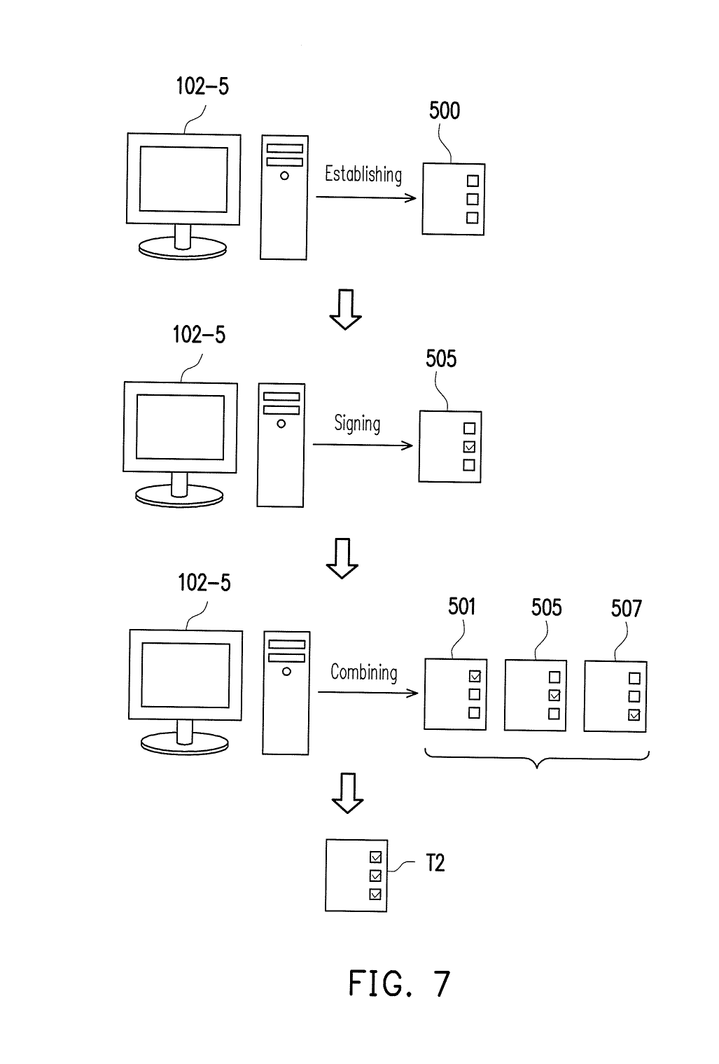

FIG. 7 is another example illustrating operations of the digital currency transaction signature according to an exemplary embodiment.

Referring to FIG. 7, in the present exemplary embodiment, it is assumed that the transaction 500 can only be valid after being signed by the digital currency transaction device 102-1, the digital currency transaction device 102-5 and the digital currency transaction device 102-7. Similarly, the digital currency transaction device 102-5 establishes the transaction 500 and signs the transaction 500 to generate a first partially-signed transaction 505. Subsequently, the digital currency transaction device 102-5 determines whether at least one second partially-signed transaction related to the transaction 500 is stored in the signature pool thereof. Herein, the at least one second partially-signed transaction related to the transaction 500 is the transaction respectively signed by the digital currency transaction device 102-1, the digital currency transaction device 102-5 and the digital currency transaction device 102-7. If the digital currency transaction device 102-5 determines that the at least one second partially-signed transaction related to the transaction 500 (i.e., a transaction 501 signed by the digital currency transaction device 102-1 and a transaction 507 signed by the digital currency transaction device 102-7) is stored in the signature pool, the digital currency transaction device 102-5 may combine the first partially-signed transaction 505 and the at least one second partially-signed transaction (501, 507) to obtain a signed transaction T2. In this case, the signed transaction T2 is the transaction signed by all of the digital currency transaction device 102-1, the digital currency transaction device 102-5 and the digital currency transaction device 102-7. Therefore, the digital currency transaction device 102-5 determines that the signed transaction T2 is valid, puts the signed transaction T2 into the memory pool, and broadcasts the signed transaction T2 to memory pools of other digital currency transaction devices in the network 104.

It is worth mentioning that, although the present exemplary embodiment is described by using the example in which one transaction is only valid after the transaction is signed by three users through their digital currency transaction devices, the invention is not intended to limit an amount of signatures signed for each transaction. For example, in another exemplary embodiment of the invention, one transaction based on the digital signature may also be valid after the transaction is signed by at least two among the three users through their digital currency transaction devices. Alternatively, in another exemplary embodiment, one transaction based on the digital signature may be valid after the transaction is signed by only two users through their digital currency transaction devices.

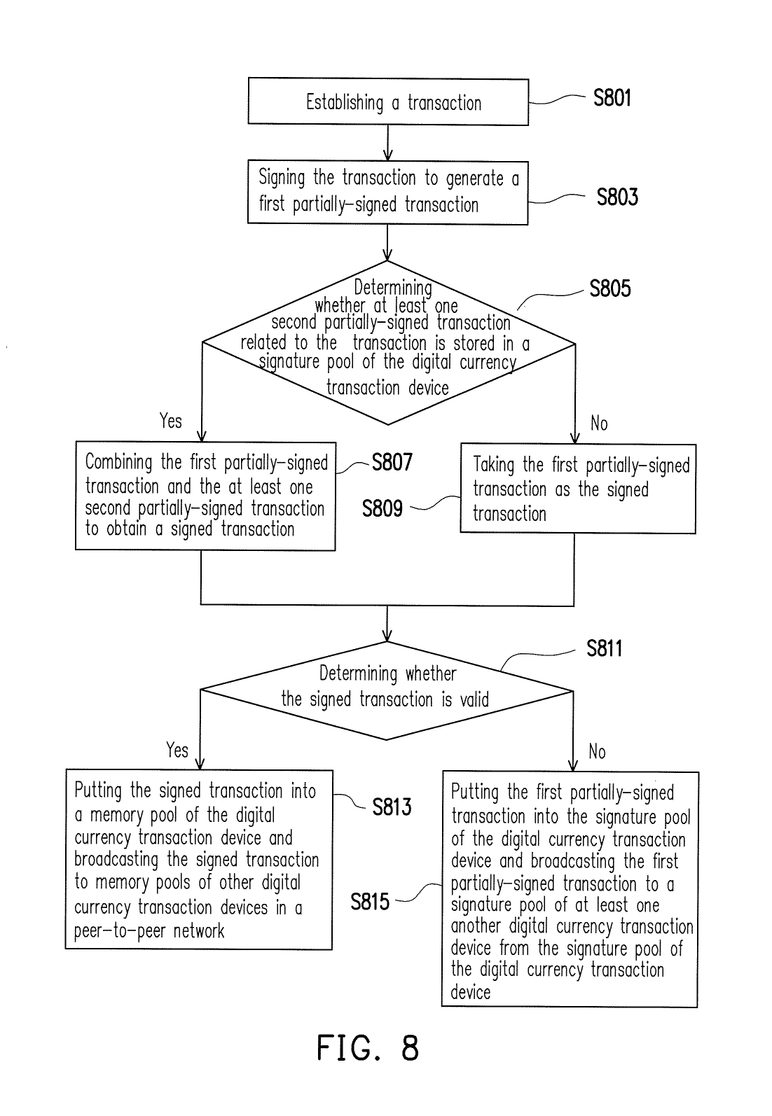

FIG. 8 is a flowchart illustrating a digital currency transaction signature method according to an exemplary embodiment.

Referring to FIG. 8, in step S801, a digital currency transaction device establishes a transaction.

In step S803, the digital currency transaction device signs the transaction to generate a first partially-signed transaction.

In step S805, the digital currency transaction device determines whether at least one second partially-signed transaction related to the transaction is stored in a signature pool of the digital currency transaction device. If the at least one second partially-signed transaction related to the transaction is stored in the signature pool of the digital currency transaction device, in step S807, the digital currency transaction device combines the first partially-signed transaction and the at least one second partially-signed transaction to obtain a signed transaction. If the at least one second partially-signed transaction related to the transaction is not stored in the signature pool of the digital currency transaction device, in step S809, the first partially-signed transaction is taken as the signed transaction.

Subsequently, in step S811, the first digital currency transaction device determines whether the signed transaction is valid.

If the signed transaction is valid, in step S813, the signed transaction is put into a memory pool of the digital currency transaction device and the signed transaction is broadcast to memory pools of other digital currency transaction devices in the peer-to-peer network.

If the signed transaction is not valid, in step S815, the first partially-signed transaction is put into the signature pool of the digital currency transaction device and the first partially-signed transaction is broadcast to a signature pool of at least one another digital currency transaction device from the signature pool of the digital currency transaction device.

Nevertheless, the steps depicted in FIG. 8 are described in detail as above, thus related description is omitted hereinafter. It should be noted that, the steps depicted in FIG. 8 may be implemented as a plurality of program codes or circuits, and the invention is not limited thereto. Moreover, the method disclosed in FIG. 8 may be implemented with reference to above embodiments or implemented separately, and the invention is not limited thereto.

In summary, according to the digital currency transaction signature method of the invention, the signature pool is established in the digital currency transaction device of each of the users to temporarily store the partially-signed transaction, and the signals are transmitted between the signature pools corresponding to each of the users to synchronize the partially-signed transaction to the signature pools of the other users. Accordingly, the invention is capable of achieving multisignature under the operating logic and mechanism of the block chain of the existing digital currency without using other external transmission methods to transmit the transaction with incomplete multisignature. Accordingly, the security of multi-signature in the digital currency transaction may be effectively enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A digital currency transaction signature method for a digital currency transaction device in a peer-to-peer network, comprising:
establishing a transaction;
signing the transaction to generate a first partially-signed transaction;
determining whether at least one second partially-signed transaction related to the transaction is stored in a signature pool of the digital currency transaction device;
if the at least one second partially-signed transaction related to the transaction is stored in the signature pool of the digital currency transaction device, combining the first partially-signed transaction and the at least one second partially-signed transaction to obtain a signed transaction;
if the at least one second partially-signed transaction related to the transaction is not stored in the signature pool of the digital currency transaction device, taking the first partially-signed transaction as the signed transaction;
determining whether the signed transaction is valid; and
if the signed transaction is not valid, putting the first partially-signed transaction into the signature pool of the digital currency transaction device and broadcasting the first partially-signed transaction to a signature pool of at least one another digital currency transaction device from the signature pool of the digital currency transaction device.

2. The digital currency transaction signature method of claim 1, wherein the step of broadcasting the first partially-signed transaction to the signature pool of the at least one another digital currency transaction device comprises:
transmitting an inquiry signal to the at least one another digital currency transaction device; and
receiving a response signal for replying the inquiry signal from the at least one another digital currency transaction device, wherein the response signal indicates whether the first partially-signed transaction is recorded in the signature pool of the at least one another digital currency transaction device.

3. The digital currency transaction signature method of claim 2, further comprising:
when the response signal indicates that the first partially-signed transaction is not recorded in the signature pool of the at least one another digital currency transaction device, transmitting the first partially-signed transaction to the signature pool of the at least one another digital currency transaction device.

4. The digital currency transaction signature method of claim 1, further comprising:
if the signed transaction is valid, putting the signed transaction into a memory pool of the digital currency transaction device and broadcasting the signed transaction to memory pools of other digital currency transaction devices in the peer-to-peer network.

5. A digital currency transaction device, comprising:
a digital currency transaction establishing module, configured to establish a transaction;
a digital currency transaction signing module, configured to sign the transaction to generate a first partially-signed transaction; and
a digital currency transaction processing module, configured to determine whether at least one second partially-signed transaction related to the transaction is stored in a signature pool of the digital currency transaction device,
wherein if the at least one second partially-signed transaction related to the transaction is stored in the signature pool of the digital currency transaction device, the digital currency transaction processing module combines the first partially-signed transaction and the at least one second partially-signed transaction to obtain a signed transaction,
wherein if the at least one second partially-signed transaction related to the transaction is not stored in the signature pool of the digital currency transaction device, the digital currency transaction processing module takes the first partially-signed transaction as the signed transaction,
wherein the digital currency transaction processing module is further configured to determine whether the signed transaction is valid,
wherein if the signed transaction is not valid, the digital currency transaction processing module is further configured to put the first partially-signed transaction into the signature pool of the digital currency transaction device and broadcast the first partially-signed transaction to a signature pool of at least one another digital currency transaction device from the signature pool of the digital currency transaction device.

6. The digital currency transaction device of claim 5, wherein the digital currency transaction processing module is further configured to transmit an inquiry signal to the at least one another digital currency transaction device,
wherein the digital currency transaction processing module is further configured to receive a response signal for replying the inquiry signal from the at least one another digital currency transaction device, wherein the response signal indicates whether the first partially-signed transaction is recorded in the signature pool of the at least one another digital currency transaction device.

7. The digital currency transaction device of claim 6, wherein when the response signal indicates that the first partially-signed transaction is not recorded in the signature pool of the at least one another digital currency transaction device, the digital currency transaction processing module is further configured to transmit the first partially-signed transaction to the signature pool of the at least one another digital currency transaction device.

8. The digital currency transaction device of claim 5, wherein if the signed transaction is valid, the digital currency transaction processing module is further configured to put the signed transaction into a memory pool of the digital currency transaction device and broadcast the signed transaction to memory pools of other digital currency transaction devices in a peer-to-peer network.

9. A digital currency transaction signature system, comprising:
a plurality of digital currency transaction devices, connected to one another via a peer-to-peer network, wherein the digital currency transaction devices comprise a first digital currency transaction device and at least one second digital currency transaction device,
wherein the first digital currency transaction device is configured to establish a transaction,
wherein the first digital currency transaction device is further configured to sign the transaction to generate a first partially-signed transaction,
wherein the first digital currency transaction device is further configured to determine whether at least one second partially-signed transaction related to the transaction is stored in a signature pool of the first digital currency transaction device,
wherein if the at least one second partially-signed transaction related to the transaction is stored in the signature pool of the first digital currency transaction device, the first digital currency transaction device combines the first partially-signed transaction and the at least one second partially-signed transaction to obtain a signed transaction,
wherein if the at least one second partially-signed transaction related to the transaction is not stored in the signature pool of the first digital currency transaction device, the first digital currency transaction device takes the first partially-signed transaction as the signed transaction,
wherein the first digital currency is further configured to determine whether the signed transaction is valid,
wherein if the signed transaction is not valid, the first digital currency transaction device is further configured to put the first partially-signed transaction into the signature pool of the first digital currency transaction device and broadcast the first partially-signed transaction to a signature pool of at least one second digital currency transaction device from the signature pool of the first digital currency transaction device.

10. The digital currency transaction signature system of claim 9, wherein the first digital currency transaction device is further configured to transmit an inquiry signal to the at least one second digital currency transaction device,
wherein the at least one second digital currency transaction device is configured to determine whether the first partially-signed transaction is stored in the signature pool of the at least one second digital currency transaction device according to the inquiry signal and transmit a response signal for replying the inquiry signal to the first digital currency transaction device.

11. The digital currency transaction signature system of claim 10, wherein when the response signal indicates that the first partially-signed transaction is not recorded in the signature pool of the at least one second digital currency transaction device, the first digital currency transaction device is further configured to transmit the first partially-signed transaction to the signature pool of the at least one second digital currency transaction device from the signature pool of the first digital currency transaction device.

12. The digital currency transaction signature system of claim 9, wherein if the signed transaction is valid, the first digital currency transaction device is further configured to put the signed transaction into a memory pool of the first digital currency transaction device and broadcast the signed transaction to memory pools of other digital currency transaction devices in the peer-to-peer network.
